(19) United States
(12) Patent Application Publication
(10) Pub. No.: US 2018/0277955 A1
(43) Pub. Date: Sep. 27, 2018

(54) MULTI-BAND ANTENNA

(71) Applicant: UNIVERSITY OF ULSAN FOUNDATION FOR INDUSTRY COOPERATION, Ulsan (KR)

(72) Inventor: HYOUNG SUK YOO, Daegu (KR)

(73) Assignee: Univerity of Ulsan Foundation for Industry Cooperation, Ulsan (KR)

(21) Appl. No.: 15/541,349

(22) PCT Filed: Nov. 2, 2016
(86) PCT No.: PCT/KR2016/012505

§ 371 Date: Oct. 24, 2017

(30) Foreign Application Priority Data
Nov. 20, 2015 (KR) 10-2015-0163559

(51) Int. Cl. H01Q 9/04; H01Q 5/50; H01Q 1/48

(52) U.S. Cl. CPC H01Q 9/045; H01Q 1/48; H01Q 5/50

(57) ABSTRACT

A multi-band antenna according to an embodiment of the present invention comprises a first ground surface having a first slot; an antenna body placed above the first ground surface and having a second slot, a feed pin and a ground surface pin; and a second ground surface formed above the antenna body.

### BACKGROUND OF THE INVENTION

### Field of the Invention

The present invention relates to a multi-band antenna and, more specifically, to a multi-band antenna appropriate for bio-signal measuring systems.

### Background of the Related Art

In the global telecommunications market, there is a growing demand for electronic appliances using a multi-band antenna rather than a single-band antenna. Importantly, a multi-band antenna has the feature of tuning to multi frequency bands. However, due to this, it performs low-quality functions in some frequency bands.

Traditional antennas are fixed ones in which a resonance point is fixed. They perform high-quality functions in a single band but do not in multi frequency bands such as a tri band or a quad band selected by antenna-switch modules (ASM) or front-end modules (FEM). This means they have the feature of a trade-off where their performance which is of high quality in a certain band becomes poor in the other bands.

### SUMMARY OF THE INVENTION

The present invention is devised to solve the problems described heretofore and the purpose of the present invention is to provide a multi-band antenna capable of multi-channel communications.

The multi-band antenna according to an embodiment of the present invention comprises a first ground surface having a first slot; an antenna body, placed above the first ground surface and having a feed pin and a ground surface pin; and a second ground surface formed above the antenna body.

Further, the first slot may have a T shape or a hook shape.

Further, the second slot may have a spiral shape.

Further, the width of the second slot may range from 0.3 mm to 1 mm.

Further, the spiral shape is formed in a line with a few bent parts.

Further, the first and second slots may be open-ended.

Further, the first slot has a T shape in which a long axis is combined with a short axis, one end of the short axis is connected with the long axis, and the other end may be perpendicularly overlapped with the feed pin of the antenna body.

Further, the first slot may be interposed between the feed pin and the ground surface pin.

Further, the second slot may be formed in the way in which a “¬”-shaped slot and a T-shaped slot are placed symmetrically to the central axis of the antenna body.

Meanwhile, the implantable device according to an embodiment of the present invention may comprise a multi-band antenna; an external unit for data communications with the multi-band antenna and for delivering control information to the multi-band antenna; and a Wireless Power Transfer (WPT) transmitter for supplying power wirelessly to the multi-band antenna.

Further, the WPT transmitter may comprise two ports and two short pins.

Further, the WPT transmitter may create three primary current paths by using the two ports and two short pins.

The multi-band antenna according to an embodiment of the present invention is capable of multi-channel communications.

### BRIEF DESCRIPTION OF THE DRAWINGS

FIG. 1 is a view showing an implantable device comprising the multi-band antenna according to an embodiment of the present invention.

FIG. 2 is a sectional side view and a top view of the multi-band antenna according to an embodiment of the present invention.

FIG. 3 is a top view showing the structure of the multi-band antennal according to an embodiment of the present invention.

FIG. 4 is a view showing electric currents depending on frequencies of the multi-band antenna according to an embodiment of the present invention.

FIG. 5 is a graph showing the refection coefficient depending on frequencies on the multi-band antenna according to an embodiment of the present invention.

FIG. 6 is a top view showing the multi-band antenna according to another embodiment of the present invention.

FIG. 7 is a top view showing the ground surface of the multi-band antenna according to another embodiment of the present invention.

FIG. 8 is a sectional side view showing the multi-band antenna according to another embodiment of the present invention.

FIG. 9 is a view showing path definition of the multi-band antenna according to another embodiment of the present invention.

FIG. 10 is a view showing path definition of the multi-band antenna modified for device integration, according to another embodiment of the present invention.

FIG. 11 illustrates the detailed structure of the transmitter having two ports and two short pins with respect to the present invention.

FIG. 12 illustrates the reflection coefficient and simulation results depending on frequencies of the multi-band antenna for the transmitter having the same structure as FIG. 11.

FIG. 13 illustrates current distribution in the transmitter having the same structure as FIG. 11.

### DETAILED DESCRIPTION OF THE PREFERRED EMBODIMENT

The technical terms in the present application are used only to explain a specific embodiment of the present invention and not intended for limiting the scope of the present invention. Also, the technical terms used in the present application shall be translated as terms generally understood by one skilled in the art to which the present invention pertains, unless explicitly defined differently and they shall not be translated as being excessively comprehensive or excessively limited. Also, if the technical terms used in the present application are too unsuitable to clearly express the technical ideas of the present invention, they should be understood in a way that they are replaced with the ones rightly understood by one skilled in the art to which the present invention pertains. Also, the usual terms used in the present application shall be translated in accordance with the meaning given by a dictionary or in accordance with the context of the present application and shall not be translated as being excessively limited.

Unless explicitly described to the contrary, the singular used in the present application includes the plural. The terms “consist of” or “comprise” in the present application do not mean necessarily including various elements or various steps described herein, and they mean that some of the elements or steps may be excluded or that additional elements or additional steps may be further included.

The preferable embodiments of the present invention will be explained in detail by reference to the attached drawings, and regardless of drawing symbols, the same or similar elements are given the same reference numerals, and repetitive explanation on the same or similar elements will be avoided.

If any detailed explanation on well-known technologies, in explaining the present invention, is considered to make the point of the present invention ambiguous, the detailed explanation will be avoided. Also, the attached drawings are provided only for better understanding of the idea of the present invention, not for limiting the idea of the present invention.

FIG. 1 is a view showing an implantable device comprising the multi-band antenna according to an embodiment of the present invention. The implantable device comprising the multi-band antenna according to an embodiment of the present invention may comprise an implantable device 1000, a transmitter and an external unit 2000.

The implantable device 1000 needs telemetry to control the device and monitor users of the implantable device (e.g. patients) by using standard programs by means of terminals such as smartphones. This makes it possible to treat individual patients in most regions. The power demand necessary for biomedical implants depends on specifications and normally ranges from a few microwatts to dozens of milliwatts. Moreover, biomedical implants require energy which comes from clean and medically safe sources to enable electronic devices to perform their functions.

The implantable device 1000 may comprise an implantable antenna 1100, a rectifier 1200, a power-managing unit 1300, a battery 1400, a communicating unit 1500, a controlling unit 1600, an analog-digital converter (ADC) 1700 and an analog-front end (AFE) 1800.

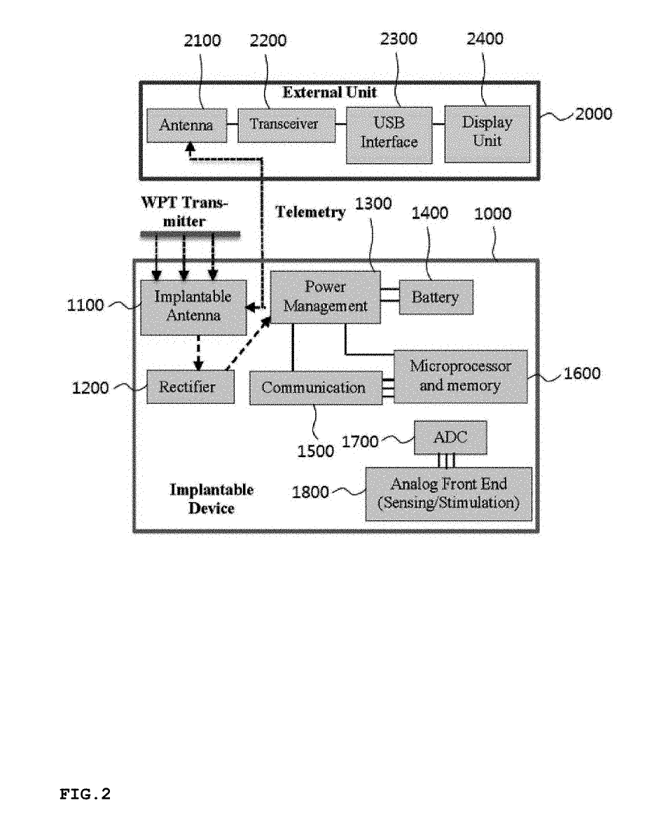

The implantable antenna 1100, configured as an electric conductor, is capable of radiating or receiving radio waves. The antenna 1100 will be described hereafter by reference to FIG. 2.

The rectifier 1200 is electric circuitry or a device focusing on rectification actions to obtain direct current from alternating current and allows current pass through only in one direction.

The power-managing unit 1300 figures out the current electric energy and the current electric energy consumption of the implantable device 1000, receives electric energy from the battery 1400 and manages electric energy necessary for the operation of the implantable device 1000. Also, the electric power-managing unit 1300 delivers the received electric energy to the battery 1400 by connecting with the implantable antenna 1100.

The communicating unit 1500 may communicate with the internal elements of the implantable device 1000 and the outside. Also, it may deliver the data collected by the implantable device 1000 to the external unit 2000 and may receive instructions from the external unit 2000.

The controlling unit 1600 generally controls operations of the elements of the implantable device. The ADC 1700 performs the function of converting the analog data received from a patient into digital signals. The AFE 1800, corresponding to a sensor, senses stimuli from the outside and then delivers the sensed signals to the ADC 1700.

The external unit 2000 may receive and transmit data and may deliver control instructions by communicating with the implantable device 1000. The external unit 2000 may comprise an antenna 2100, a transceiver 2200, an interface 2300 and a display 2400.

FIG. 2 is a sectional side view and a top view of the multi-band antenna according to an embodiment of the present invention. The multi-band antenna according to an embodiment of the present invention may be formed to comprise a first ground surface 1110, an antenna body 1120 and a second ground surface 1130.

The antenna according to an embodiment of the present invention is a planar inverted-F (PIFA) antenna having a spiral shape. The spiral shape may be formed in a curve as well as in a line with bent parts.

A PIFA is normally light in weight and easy to adapt into a device chassis and it has an appropriate range of bandwidth. Further, it has an omni directional radiation pattern for a vertical polarization in a principal plane and has flexibility for optimization and it may be scaled down in various.

The first ground surface 1110, the antenna body 1120 of an electric conductor, the antenna body 1120 and the second ground surface 1130 are formed to be placed at equal distances apart. In detail, the first ground surface 1110 and the antennal body 1120 are placed at a distance of 0.025 mm from each other, and the antenna body 1120 and the second ground surface 1130 are also placed at a distance of 0.025 mm from each other.

To tune the antenna to three frequencies, the first ground surface 1110 has a T-shaped slot 1111. The width of the T-shaped slot is approximately 0.6. mm. Such measurements are presented only to give an example and are not restrictive.

Polyamide, a dielectric substance which is biocompatible and elastic, may be used as the first ground surface 1110 and the second ground surface 1130 (εr=4.3, tan δ=0.004, width=0.025 mm)

As shown in FIG. 2, one end of the short axis of the T-shaped slot 1111 formed on the first ground surface 1110 is connected with the long axis, and the other end of the short axis may be perpendicularly overlapped with the power-supplying pin of the antenna body 1120. In an embodiment of the present invention, the antennal body 1120 has a width of 31 mm and a length of 20.5 mm but such measurements are not restrictive. Also, measurements described hereafter are presented only to give an example on the basis of the size of the antennal body 1120 and they are not restrictive.

The T-shaped slot 1111 may be formed by combining a short axis with a long axis, the long axis may be formed across the first ground surface 1110, and the short axis may have its one end contacting the long axis. The short axis and the long axis may be formed at a right angle to each other. The T-shaped slot 1111 may be 0.6 mm wide.

The long axis and the short axis have a certain length. For instance, the long axis may be 19.7 mm long and the short axis may be 3.7 mm long. The long axis may be place at a certain distance apart from the central axis of the first ground surface 1110. For instance, the long axis may be placed at a distance of 10. 65 mm apart from one side of the ground surface 1110.

The other end of the short axis of the T-shaped slot 1111 may be formed at the position where the other end of the short axis of the T-shaped slot is perpendicularly overlapped with the feed element of the antennal body 1120.

The feed pin and the ground surface pin formed in the antennal body 1120 may be placed to oppose each other with respect to the T-shaped slot 1111 of the perpendicularly overlapped first ground surface 1110. This means the perpendicularly overlapped T-shaped slot 1111 is interposed between the feed pin and ground surface pin. Also, the short axis of the T-shaped slot 1111 is formed to perpendicularly overlap with the feed pin.

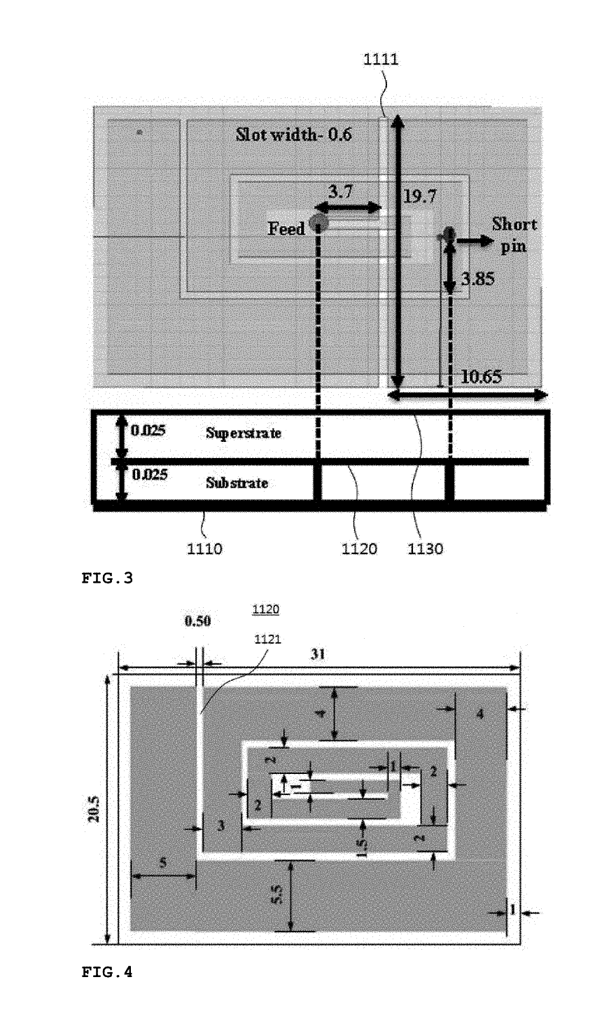

FIG. 3 is a top view showing the multi-band antenna according to an embodiment of the present invention. As illustrated, a spiral-shaped slot 1121 is formed. The spiral-shaped slot 1121 starts to be formed on one side of the antenna body 1120 and bends a few times towards the interior of the antenna body.

That is, the spiral-shaped slot 1121 is formed in the way that it starts to be formed as a line with a certain length parallel to the vertical axis and bends towards the interior at a right angle and then is formed in a line with a certain length again. The length of each line is described in FIG. 3, and for instance, the width of the spiral-shaped slot 1121 may range from 0.3 mm to 1 mm, preferably 0.5 mm. The spiral-shaped slot 1121 is formed to bend towards the interior of the antenna body 1120, and basically, the width of the spiral-shaped slot 1121 is 0.5 mm but it may be 2 mm, four times wider than the basic width of 0.5 mm. A feed pin having conductivity may be used for wireless frequency power supplies.

FIG. 4 is a view showing current distribution depending on frequencies of the multi-band antenna according to an embodiment of the present invention. The current distribution shows the distribution of current lines in a conductor. Three different types of current distribution may be created on three required frequencies by adjusting the position of a ground surface slot.

FIG. 4A shows current distribution for a Medical Implant Communication Service (MICS) band in PIFA mode. Frequency bands of MICS range from 402 to 405 MHz.

FIG. 4B shows current distribution in loop mode. The midfield band (lower gigahertz: 1.45 to 1.6 GHz) for WPT may be realized in loop mode. In a loop-mode antenna, the direction of current changes reversely at every one-quarter wavelength.

FIG. 4C shows current distribution in dipole mode. The Industrial, Scientific and Medical (ISM) band for triggering or power conservation, as shown in FIG. 4C, may be realized in dipole mode. The frequency bands of ISM may range from 2.4 to 2.45 GHz by using a T-shaped ground surface slot.

As shown in FIG. 4D, a ground surface slot may adjusted for the purpose of tuning. Also, the location of a ground surface pin as well as the width and length of a patch element may be adjusted for the purpose of tuning. As shown in FIG. 4D, the length of the long axis of the T-shaped slot 1111 controls the MICS band while the length of the short axis controls the ISM band, and the location of the slot may move to the right or to the left for tuning in 1.5 GHz.

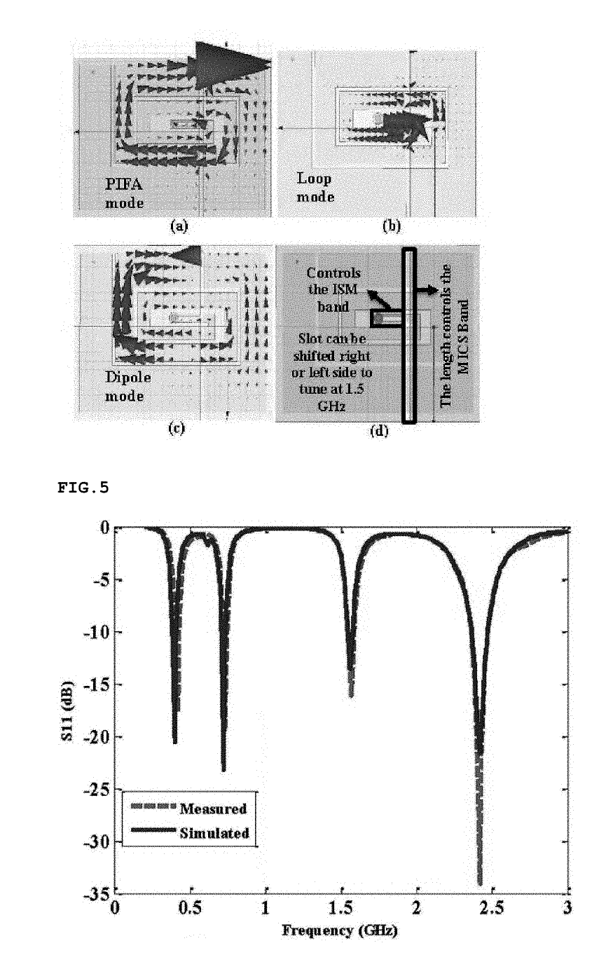

FIG. 5 is a graph showing the reflection coefficient depending on frequencies of the multi-band antenna according to an embodiment of the present invention. As shown in FIG. 5, the antenna according to an embodiment of the present invention has four resonance frequencies. The second resonant frequency band of 700 to 750 MHz may be used for communication inside the body.

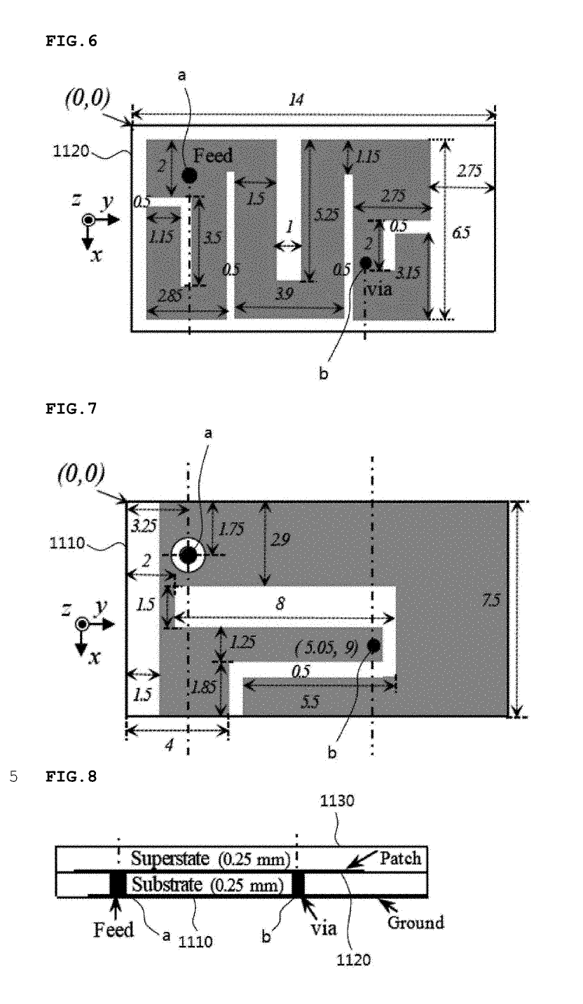

FIG. 6 is a top view of the multi-band antenna according to another embodiment of the present invention. For instance, it has the size of 14 mm×7.5 mm×0.5 mm (52.5 mm³). As shown in FIG. 6, the antenna body 1120 configured as a radiating patch may have a serpent-shaped slot, a coaxial feed pin (a) and a ground surface pin (b). The slot may be formed symmetrically to the central axis of the antenna body 1120. For instance, a “¬”-shaped slot and a T-shaped slot are placed symmetrically to the central axis of the antenna body 1120.

The coaxial feed pin (a) and the ground surface pin (b) may be formed respectively on each side of the central axis of the antenna body 1120.

FIG. 7 is a top view showing the ground surface of the multi-band antenna according to another embodiment of the present invention, and FIG. 8 is a sectional side view of the multi-band antenna according to an embodiment of the present invention. FIGS. 6 to 8 show the location of the coaxial feed pin (a) and the ground surface pin (b).

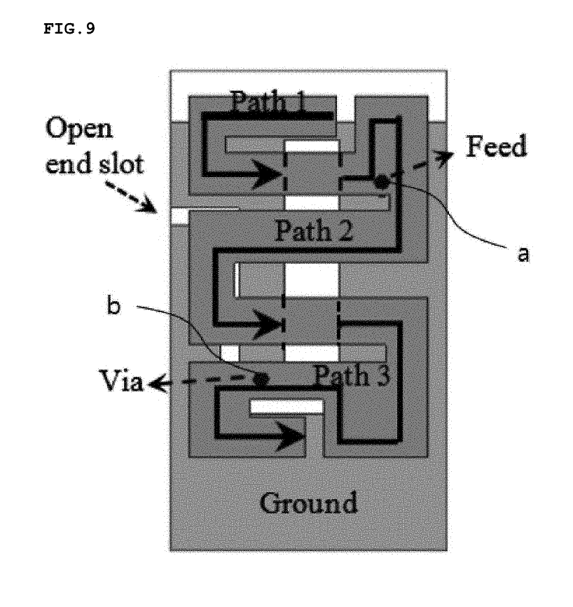

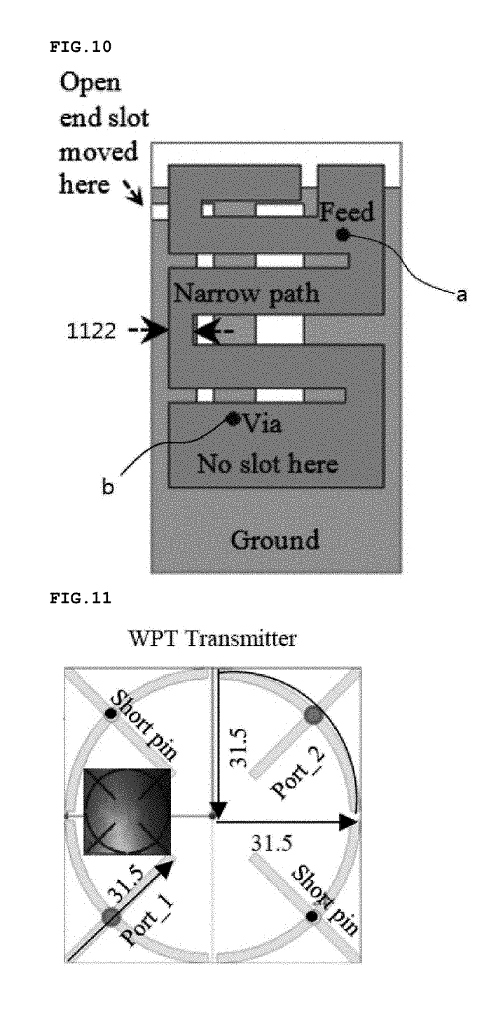

Further, FIG. 9 is a view showing the path definition of the multi-band antenna according to another embodiment of the present invention, and FIG. 10 is a view showing the path definition of the multi-band antenna, modified for device integration according to another embodiment of the present invention.

The ground surface 1110 of the multi-band antenna according to another embodiment of the present invention may have a hook-shaped slot with its one end open. Having one end open has the effect of dramatically minimizing the size.

To operate the antenna system, the antenna body 1120 is divided into three parts (path 1 to path 3). Path 2 is active in 2450 MHz mode while path 3 is active in 915 MHz. The lowest frequency mode of 405 MHz is excited by a total length such as the total of path 1 to path 3.

To deal with the detuning caused by device incorporation, as shown in FIG. 10, in the antenna body 1120, the location of the open-ended ground surface slot is changed. Further, the width of path 2 becomes narrower than in FIG. 9.

Meanwhile, the present invention suggests a WPT transmitter having two ports and two short pins to operate an implantable device, comprising the multi-band antenna presented in the present invention, in deep tissue efficiently.

That is, the complexity of the system may be eased because the system can be managed with less number of ports by using two ports and two short pins, rather than using four ports, to keep equal current circulation.

FIG. 11 shows the detailed structure of the transmitter having two ports and two short pins in relation to the present invention.

By reference to FIG. 11, the transmitter is embodied as a patterned metal plate having a slot.

A transmitter with such a structure may be excited by an independent wireless frequency port.

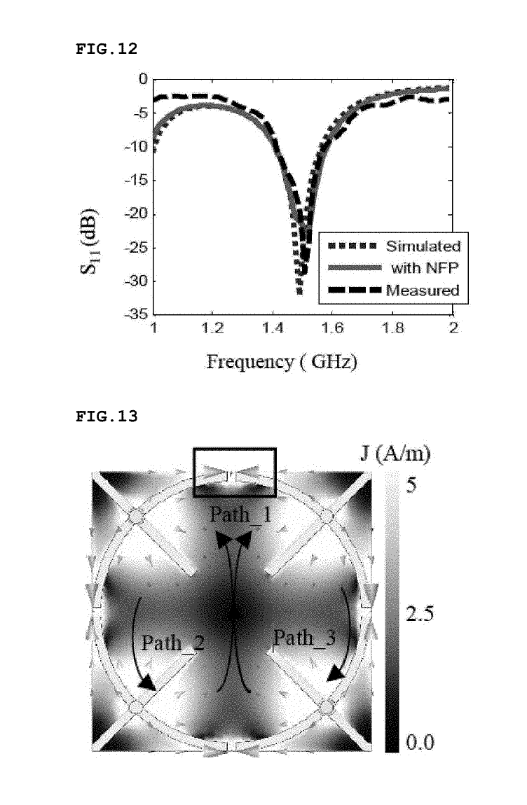

FIG. 12 shows the reflection coefficient and simulation results depending on frequencies of the multi-band antenna for the transmitter having the same structure as FIG. 11.

Further, FIG. 13 shows current distribution in the transmitter having the same structure as FIG. 11.

By reference to FIG. 13, three primary current paths are created by two ports and two short pins.

Accordingly, a transmitter having two ports and two short pins has the same effect as that having four ports does. Thanks to this, the system can be managed with less number of ports and as a result, the complexity of the system may be eased.

The feature, structure and effect in the above described embodiments are included in at least one of the embodiments of the present invention but not necessarily limited to one embodiment. Further, one skilled in the art to which the embodiments pertain may practice other embodiments by combining or changing the feature, structure and effect in each exemplary embodiment.

Accordingly, anything related to such a combination and change shall be translated as being included in the scope of the present invention. Also, although the description mentioned heretofore focuses on exemplary embodiments, the embodiments are just examples and do not limit the scope of the present invention. One skilled in the art to which the present invention pertains can understand that a variety of changes and applications not described heretofore are possible within the scope and range of the essential features of the present embodiments. For instance, each element described in detail in the embodiments can be changed to practice other embodiments. Further, any differences in relation to such a change and application shall be translated as being included in the scope of the present invention defined in the claims attached.

### PARTS LIST

1000: Implantable device

1. A multi-band antenna comprising:
a first ground surface having a first slot;
an antenna body placed above the first ground surface and having a second slot, a feed pin and a ground surface pin; and
a second ground surface configured above the antenna body.

2. The multi-band antenna according to claim 1,
wherein the first slot has a T shape or a hook shape.

3. The multi-band antenna according to claim 1,
wherein the second slot has a spiral shape.

4. The multi-band antenna according to claim 1,
wherein the width of the second slot ranges from 0.3 mm to 1 mm.

5. The multi-band antenna according to claim 3,
wherein the spiral shape is formed in a line with a few bent parts.

6. The multi-band antenna according to claim 1,
wherein the first slot and second slots are open-ended slots.

7. The multi-band antenna according to claim 2,
wherein the first slot is a T-shaped slot in which a long axis and a short axis are combined, one end of the short axis is combined with the long axis and the other end is perpendicularly overlapped with the feed pin of the antenna body.

8. The multi-band antenna according to claim 1,
wherein the first slot is interposed between the feed pin and the ground surface pin.

9. The multi-band antenna according to claim 1,
wherein the second slot has a ‘¬-shaped slot and a ‘T’-shaped slot which are placed symmetrically to the central axis.

10-12. (canceled)

13. An implantable device comprising;
the multi-band antenna according to claim 1;
an external unit for data communications with the multi-band antenna and for delivering control information to the multi-band antenna; and
a Wireless Power Transfer transmitter for supplying power wirelessly to the multi-band antenna.

14. The implantable device according to claim 13,
wherein the WPT transmitter comprises two ports and two short pins.

15. The implantable device according to claim 14,
wherein the WPT transmitter creates three primary current paths by using the two ports and two short pins.
